(19) United States
(12) Patent Application Publication
(10) Pub. No.: US 2022/0099929 A1
(43) Pub. Date: Mar. 31, 2022

(54) SEVEN-PIECE OPTICAL LENS SYSTEM

(71) Applicant: NEWMAX TECHNOLOGY CO., LTD., TAICHUNG CITY (TW)

(72) Inventors: CHING-YUN HUANG, TAICHUNG CITY (TW); Chun-Sheng LEE, TAICHUNG CITY (TW); Sian-Chih KE, TAICHUNG CITY (TW); Shu-Tzu LAI, TAICHUNG CITY (TW)

(21) Appl. No.: 17/035,673

(22) Filed: Sep. 28, 2020

(51) Int. Cl. G02B 13/00; G02B 9/64

(52) U.S. Cl. CPC G02B 13/0045; G02B 9/64

(57) ABSTRACT

A seven-piece optical lens system includes, in order from the object side to the image side: a stop; a first lens element with a positive refractive power; a second lens element with a negative refractive power; a third lens element with a refractive power, a fourth lens element with a positive refractive power; a fifth lens element with a refractive power; a sixth lens element with a positive refractive power; and a seventh lens element with a negative refractive power. Such arrangements can provide a miniaturized seven-piece optical lens system having a big stop and high image quality.

### BACKGROUND

### Field of the Invention

The present invention relates to a seven-piece optical lens system, and more particularly to a miniaturized seven-piece optical lens system applicable to electronic products.

### Description of the Prior Art

In recent years, with the rapid development of portable electronic products, such as, smartphone, tablet computer and so on, small optical lens system applied to portable electronic products has been indispensable. In addition, as the advanced semiconductor manufacturing technologies have allowed the image sensors with smaller size and higher pixel, small optical lens systems have increasingly higher pixel, there's an increasing demand for an optical lens system with better image quality.

Conventional miniaturized optical lens systems used in portable electronic products mostly consist of five lens elements, however, since the high profile portable electronic products, such as smart phone, wearable device and tablet personal computer, are becoming prevalent, the demand for resolution and imaging quality of the miniaturized optical lens systems also increases. The conventional five-piece lens system cannot satisfy higher demand.

Currently, conventional six-piece optical lens systems is developed to provide imaging lens systems with big stop and high image quality, however, the total track length of these optical lens systems is too long, and it is difficult to have the characteristics of big stop, high image quality and miniaturization, which are not applicable to portable electronic products.

The present invention mitigates and/or obviates the aforementioned disadvantages.

### SUMMARY

The primary objective of the present invention is to provide a miniaturized seven-piece optical lens system having a big stop and high image quality.

Therefore, a seven-piece optical lens system in accordance with the present invention comprises a stop and a lens group having seven lens elements, in order from an object side to an image side:

the stop; a first lens element with a positive refractive power having an object-side surface being convex near an optical axis and an image-side surface being concave near the optical axis, at least one of the object-side surface and the image-side surface of the first lens element being aspheric; a second lens element with a negative refractive power having an object-side surface being convex near the optical axis and an image-side surface being concave near the optical axis, at least one of the object-side surface and the image-side surface of the second lens element being aspheric; a third lens element with a refractive power having an object-side surface being convex near the optical axis and an image-side surface being concave near the optical axis, at least one of the object-side surface and the image-side surface of the third lens element being aspheric; a fourth lens element with a positive refractive power having an image-side surface being convex near the optical axis, at least one of an object-side surface and the image-side surface of the fourth lens element being aspheric; a fifth lens element with a refractive power having an object-side surface being convex near the optical axis and an image-side surface being concave near the optical axis, at least one of the object-side surface and the image-side surface of the fifth lens element being aspheric; a sixth lens element with a positive refractive power having an object-side surface being convex near the optical axis, at least one of the object-side surface and an image-side surface of the sixth lens element being aspheric; and a seventh lens element with a negative refractive power having an object-side surface being concave near the optical axis and an image-side surface being concave near the optical axis, at least one of the object-side surface and the image-side surface of the seventh lens element being aspheric and provided with at least one inflection point.

Wherein a focal length of the seven-piece optical lens system is f, a radius of curvature of the object-side surface of the seventh lens element is R13, a radius of curvature of the image-side surface of the seventh lens element is R14, and they satisfy the relation: −0.28 mm⁻¹<f/(R13*R14)<−0.10 mm⁻¹.

If R13*R14 satisfies the above relation, the shape of the seventh lens element can be controlled effectively, so as to make the image-side surface of the seventh lens element has stronger optical path control ability, thus optimizing the image quality.

Preferably, a focal length of the first lens element is f1, a radius of curvature of the image-side surface of the first lens element is R2, and they satisfy the relation: 0.35<f1/R2<0.60, so that the curvature of the image-side surface of the first lens element will be appropriate, it will be favorable to reduce the total length of the seven-piece optical lens system.

Preferably, a focal length of the second lens element is f2, a focal length of the seventh lens element is f7, and they satisfy the relation: 2.7<f2/f7<4.5, so that the refractive powers of the lens elements can be adjusted, which is favorable to correct the aberration, reduce the total track length and adjust the field of view.

Preferably, a focal length of the third lens element and the fourth lens element combined is 134, the focal length of the first lens element is f1, the focal length of the second lens element is 12, and they satisfy the relation: −12.8 mm⁻¹<f34/(f1*f2)<3.2 mm⁻¹, so that the refractive powers of the lens elements can be adjusted, which is favorable to correct the aberration, reduce the total track length and adjust the field of view.

Preferably, the focal length of the first lens element is f1, the focal length of the second lens element is f2, and they satisfy the relation: −0.5<f1/f2<−0.25, so that the refractive powers of the lens elements can be adjusted, which is favorable to correct the aberration, reduce the total track length and adjust the field of view.

Preferably, a radius of curvature of the object-side surface of the first lens element is R1, the radius of curvature of the image-side surface of the first lens element is R2, and they satisfy the relation: 0.15<R1/R2<0.27, so that the shape of the first lens element can be controlled effectively, which is favorable to balance the aberration of the seven-piece optical lens system.

Preferably, a focal length of the seventh lens element is f7, the radius of curvature of the object-side surface of the seventh lens element is R13, the radius of curvature of the image-side surface of the seventh lens element is R14, and they satisfy the relation: 5.3 mm<R13*R14/f7<14.0 mm, so that the shape of the seventh lens element can be controlled effectively, which makes the image-side surface of the seventh lens element has stronger optical path control ability, thus optimizing the image quality.

Preferably, a central thickness of the first lens element along the optical axis is CT1, a central thickness of the second lens element along the optical axis is CT2, a central thickness of the third lens element along the optical axis is CT3, a distance from the object-side surface of the first lens element to an image plane along the optical axis is TL, and they satisfy the relation: 0.17<(CT1+CT2+CT3)/TL<0.3, so that the reducing of the volume of the system and the increasing of the image plane area can be balanced.

Preferably, the distance from the object-side surface of the first lens element to the image plane along the optical axis is TL, a distance from the image-side surface of the seventh lens element to the image plane along the optical axis is BFL, the focal length of the first lens element is f1, and they satisfy the relation: 0.93<(TL−BFL)/f1<1.45, which ensures that the first lens element has sufficient refractive power to allow the peripheral light to converge on the image plane.

Preferably, a focal length of the fifth lens element is f5, a radius of curvature of the object-side surface of the fifth lens element is R9, a radius of curvature of the image-side surface of the fifth lens element is R10, and they satisfy the relation: −46.8 mm⁻¹<f5/(R9*R10)<2.7 mm⁻¹, so that the shape of the fifth lens element can be controlled effectively, which makes the image-side surface of the fifth lens element has stronger optical path control ability, thus optimizing the image quality.

Preferably, the focal length of the seven-piece optical lens system is f, the distance from the object-side surface of the first lens element to the image plane along the optical axis is TL, and they satisfy the relation: 0.92<TL/f<1.41, it will be favorable to obtain a wide field of view and maintain the objective of miniaturization of the seven-piece optical lens system, which can be used in thin electronic products.

Preferably, half of an image height that can be captured by the seven-piece optical lens system on the image plane is IMH, the distance from the object-side surface of the first lens element to the image plane along the optical axis is TL, and they satisfy the relation: 0.6<IMH/TL<0.96, so that the reducing of the volume of the system and the increasing of the image plane area can be balanced.

Preferably, an Abbe number of the first lens element is V1, an Abbe number of the second lens element is V2, and they satisfy the relation: 29<V1-V2<45, so that the chromatic aberration of the seven-piece optical lens system can be modified effectively.

The present invention will be presented in further details from the following descriptions with the accompanying drawings, which show, for purpose of illustrations only, the preferred embodiments in accordance with the present invention.

### BRIEF DESCRIPTION OF THE DRAWINGS

FIG. 1A shows a seven-piece optical lens system in accordance with a first embodiment of the present invention;

FIG. 1B shows the image plane curve and the distortion curve of the first embodiment of the present invention;

FIG. 2A shows a seven-piece optical lens system in accordance with a second embodiment of the present invention;

FIG. 2B shows the image plane curve and the distortion curve of the second embodiment of the present invention;

FIG. 3A shows a seven-piece optical lens system in accordance with a third embodiment of the present invention;

FIG. 3B shows the image plane curve and the distortion curve of the third embodiment of the present invention;

FIG. 4A shows a seven-piece optical lens system in accordance with a fourth embodiment of the present invention;

FIG. 4B shows the image plane curve and the distortion curve of the fourth embodiment of the present invention;

FIG. 5A shows a seven-piece optical lens system in accordance with a fifth embodiment of the present invention;

FIG. 5B shows the image plane curve and the distortion curve of the fifth embodiment of the present invention;

FIG. 6A shows a seven-piece optical lens system in accordance with a sixth embodiment of the present invention; and

FIG. 6B shows the image plane curve and the distortion curve of the sixth embodiment of the present invention.

### DETAILED DESCRIPTION

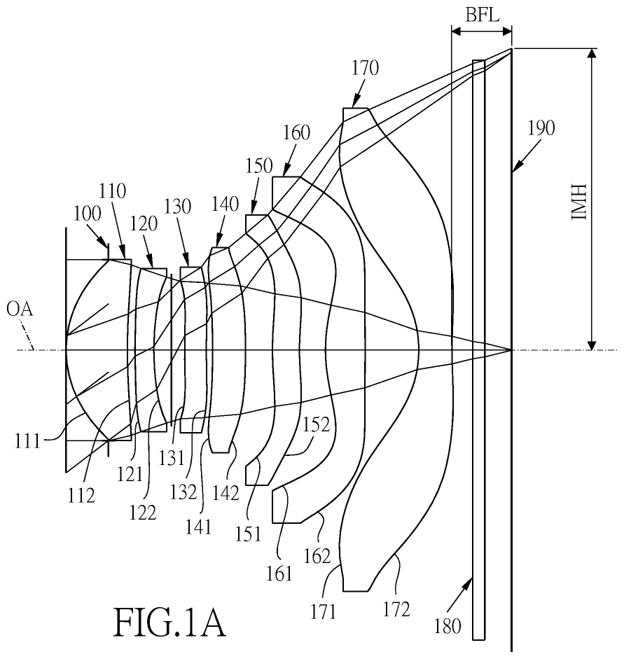

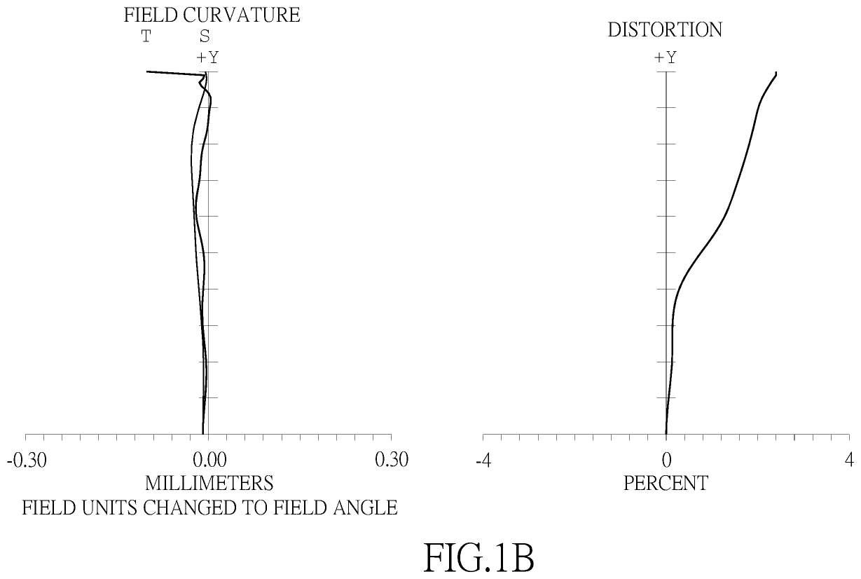

Referring to FIGS. 1A and 1B, FIG. 1A shows a seven-piece optical lens system in accordance with a first embodiment of the present invention, and FIG. 1B shows, in order from left to right, the image plane curve and the distortion curve of the first embodiment of the present invention. A seven-piece optical lens system in accordance with the first embodiment of the present invention comprises a stop 100 and a lens group. The lens group comprises, in order from an object side to an image side: a first lens element 110, a second lens element 120, a third lens element 130, a fourth lens element 140, a fifth lens element 150, a sixth lens element 160, a seventh lens element 170, an IR cut filter 180, and an image plane 190, wherein the seven-piece optical lens system has a total of seven lens elements with refractive power. The stop 100 is disposed between an image-side surface 112 of the first lens element 110 and an object to be imaged.

The first lens element 110 with a positive refractive power has an object-side surface 111 being convex near an optical axis OA and the image-side surface 112 being concave near the optical axis OA, the object-side surface 111 and the image-side surface 112 are aspheric, and the first lens element 110 is made of plastic material.

The second lens element 120 with a negative refractive power has an object-side surface 121 being convex near the optical axis OA and an image-side surface 122 being concave near the optical axis OA, the object-side surface 121 and the image-side surface 122 are aspheric, and the second lens element 120 is made of plastic material.

The third lens element 130 with a negative refractive power has an object-side surface 131 being convex near the optical axis OA and an image-side surface 132 being concave near the optical axis OA, the object-side surface 131 and the image-side surface 132 are aspheric, and the third lens element 130 is made of plastic material.

The fourth lens element 140 with a positive refractive power has an object-side surface 141 being concave near the optical axis OA and an image-side surface 142 being convex near the optical axis OA, the object-side surface 141 and the image-side surface 142 are aspheric, and the fourth lens element 140 is made of plastic material.

The fifth lens element 150 with a negative refractive power has an object-side surface 151 being convex near the optical axis OA and an image-side surface 152 being concave near the optical axis OA, the object-side surface 151 and the image-side surface 152 are aspheric and are provided with at least one inflection point, and the fifth lens element 150 is made of plastic material.

The sixth lens element 160 with a positive refractive power has an object-side surface 161 being convex near the optical axis OA and an image-side surface 162 being convex near the optical axis OA, the object-side surface 161 and the image-side surface 162 are aspheric and are provided with at least one inflection point, and the sixth lens element 160 is made of plastic material.

The seventh lens element 170 with a negative refractive power has an object-side surface 171 being concave near the optical axis OA and an image-side surface 172 being concave near the optical axis OA, the object-side surface 171 and the image-side surface 172 are aspheric and are provided with at least one inflection point, and the seventh lens element 170 is made of plastic material.

The IR cut filter 180 made of glass is located between the seventh lens element 170 and the image plane 190 and has no influence on the focal length of the seven-piece optical lens system.

The equation for the aspheric surface profiles of the respective lens elements of the first embodiment is expressed as follows:

$$z = \frac{{ch}^{2}}{1 + {[ 1 - ( k + 1 ) {c}^{2} {h}^{2} ]}^{0.5}} + {Ah}^{4} + {Bh}^{6} + {Ch}^{8} + {Dh}^{10} + {Eh}^{12} + {Fh}^{14} + {Gh}^{16}$$

wherein:

z represents the value of a reference position with respect to a vertex of the surface of a lens and a position with a height h along the optical axis OA;

c represents a paraxial curvature equal to 1/R (R: a paraxial radius of curvature);

h represents a vertical distance from the point on the curve of the aspheric surface to the optical axis OA;

k represents the conic constant;

A, B, C, D, E, F, G, . . . : represent the high-order aspheric coefficients.

In the first embodiment of the present seven-piece optical lens system, a focal length of the seven-piece optical lens system is f, a f-number of the seven-piece optical lens system is Fno, the seven-piece optical lens system has a maximum view angle (field of view 2ω) FOV, and they satisfy the relations: f=6.63 mm; Fno=1.79; and FOV=83.7 degrees.

In the first embodiment of the present seven-piece optical lens system, the focal length of the seven-piece optical lens system is f, a radius of curvature of the object-side surface 171 of the seventh lens element 170 is R13, a radius of curvature of the image-side surface 172 of the seventh lens element 170 is R14, and they satisfy the relation: f/(R13*R14)=−0.228 mm⁻¹.

In the first embodiment of the present seven-piece optical lens system, a focal length of the first lens element 110 is f1, a radius of curvature of the image-side surface 112 of the first lens element 110 is R2, and they satisfy the relation: f1/R2=0.437.

In the first embodiment of the present seven-piece optical lens system, a focal length of the second lens element 120 is f2, a focal length of the seventh lens element 170 is f7, and they satisfy the relation: f2/f7=3.723.

In the first embodiment of the present seven-piece optical lens system, a focal length of the third lens element 130 and the fourth lens element 140 combined is f34, the focal length of the first lens element 110 is f1, the focal length of the second lens element 120 is f2, and they satisfy the relation: f34/(f1*f2)=−2.002 mm⁻¹.

In the first embodiment of the present seven-piece optical lens system, the focal length of the first lens element 110 is f1, the focal length of the second lens element 120 is f2, and they satisfy the relation: f1/f2=−0.388.

In the first embodiment of the present seven-piece optical lens system, a radius of curvature of the object-side surface 111 of the first lens element 110 is R1, the radius of curvature of the image-side surface 112 of the first lens element 110 is R2, and they satisfy the relation: R1/R2=0.198.

In the first embodiment of the present seven-piece optical lens system, a focal length of the seventh lens element 170 is f7 the radius of curvature of the object-side surface 171 of the seventh lens element 170 is R13, the radius of curvature of the image-side surface 172 of the seventh lens element 170 is R14, and they satisfy the relation: R13*R14/f7=7.269 mm.

In the first embodiment of the present seven-piece optical lens system, a central thickness of the first lens element 110 along the optical axis OA is CT1, a central thickness of the second lens element 120 along the optical axis OA is CT2, a central thickness of the third lens element 130 along the optical axis OA is CT3, a distance from the object-side surface 111 of the first lens element 110 to the image plane 190 along the optical axis OA is TL, and they satisfy the relation: (CT1+CT2+CT3)/TL=0.228.

In the first embodiment of the present seven-piece optical lens system, the distance from the object-side surface 111 of the first lens element 110 to the image plane 190 along the optical axis OA is TL, a distance from the image-side surface 172 of the seventh lens element 170 to the image plane 190 along the optical axis OA is BFL, the focal length of the first lens element 110 is f1, and they satisfy the relation: (TL−BFL)/f1=1.165.

In the first embodiment of the present seven-piece optical lens system, a focal length of the fifth lens element 150 is f5, a radius of curvature of the object-side surface 151 of the first lens element 150 is R9, a radius of curvature of the image-side surface 152 of the first lens element 150 is R10, and they satisfy the relation: f5/(R9*R10)=−2.912 mm⁻¹.

In the first embodiment of the present seven-piece optical lens system, the focal length of the seven-piece optical lens system is f, the distance from the object-side surface 111 of the first lens element 110 to the image plane 190 along the optical axis OA is TL, and they satisfy the relation: TL/f=1.173.

In the first embodiment of the present seven-piece optical lens system, half of an image height that can be captured by the seven-piece optical lens system on the image plane 190 is IMH, the distance from the object-side surface 111 of the first lens element 110 to the image plane 190 along the optical axis OA is TL, and they satisfy the relation: IMH/TL=0.784.

In the first embodiment of the present seven-piece optical lens system, an Abbe number of the first lens element 110 is V1, an Abbe number of the second lens element 120 is V2, and they satisfy the relation: V1−V2=36.8.

The detailed optical data of the first embodiment is shown in table 1, and the aspheric surface data is shown in table 2.

TABLE 1
Embodiment 1
f(focal length) = 6.63 mm, Fno = 1.79, FOV = 83.7 deg.

| surface | | Curvature Radius | | Thickness | Material | Index | Abbe # | Focal length |
|---|---|---|---|---|---|---|---|---|
| 0 | object | infinity | | infinity | | | | |
| 1 | | infinity | | 0.740 | | | | |
| 2 | stop | infinity | | −0.740 | | | | |
| 3 | Lens 1 | 2.622 | (ASP) | 1.067 | plastic | 1.54 | 56 | 5.78 |
| 4 | | 13.227 | (ASP) | 0.132 | | | | |
| 5 | Lens 2 | 18.168 | (ASP) | 0.330 | plastic | 1.67 | 19.2 | −14.91 |
| 6 | | 6.444 | (ASP) | 0.310 | | | | |
| 7 | shading surface | infinity | | 0.233 | | | | |
| 8 | Lens 3 | 19.874 | (ASP) | 0.373 | plastic | 1.67 | 19.2 | −705.79 |
| 9 | | 18.937 | (ASP) | 0.110 | | | | |
| 10 | Lens 4 | −31.282 | (ASP) | 0.577 | plastic | 1.54 | 56 | 137.89 |
| 11 | | −22.247 | (ASP) | 0.471 | | | | |
| 12 | Lens 5 | 6.696 | (ASP) | 0.470 | plastic | 1.54 | 56 | −115.10 |
| 13 | | 5.902 | (ASP) | 0.453 | | | | |
| 14 | Lens 6 | 3.847 | (ASP) | 0.693 | plastic | 1.54 | 56 | 6.24 |
| 15 | | −28.118 | (ASP) | 0.939 | | | | |
| 16 | Lens 7 | −2.835 | (ASP) | 0.575 | plastic | 1.54 | 56 | −4.00 |
| 17 | | 10.268 | (ASP) | 0.367 | | | | |

| | | | | | | | |
|---|---|---|---|---|---|---|---|
| 18 | IR-filter | infinity | 0.210 | glass | 1.52 | 64.2 | — |
| 19 | | infinity | 0.465 | | | | |
| 20 | Image plane | infinity | — | | | | |

TABLE 2
Aspheric Coefficients

| surface | 3 | 4 | 5 | 6 | 8 | 9 |
|---|---|---|---|---|---|---|
| K: | −7.6506E−01 | 3.9314E+01 | 8.4247E+01 | −1.8573E+01 | 7.7529E+01 | 9.8436E+01 |
| A: | 0.0000E+00 | 0.0000E+00 | 0.0000E+00 | 0.0000E+00 | 0.0000E+00 | 0.0000E+00 |
| B: | 6.0199E−03 | −1.4916E−02 | −1.8861E−02 | 3.7857E−03 | −2.1546E−02 | −1.2584E−02 |
| C: | −4.7426E−04 | 7.7755E−03 | 1.7058E−02 | 9.0819E−03 | −1.4235E−02 | −2.3788E−02 |
| D: | 1.6063E−03 | −4 4415E−03 | −8.5028E−03 | −1.1407E−03 | 1.6147E−02 | 2.0457E−02 |
| E: | −1.1188E−03 | 2.1697E−03 | 3.5975E−03 | −2.6017E−03 | −1.2588E−02 | −1.0438E−02 |
| F: | 4.1936E−04 | −8.4240E−04 | −1.2125E−03 | 2.3142E−03 | 5.2121E−03 | 3.3744E−03 |
| G: | −7.8213E−05 | 1.8179E−04 | 2.6670E−04 | −8.0087E−04 | −1.1637E−03 | −6.1955E−04 |
| H: | 4.7487E−06 | −1.6125E−05 | −2.3487E−05 | 1.1244E−04 | 1.1506E−04 | 4.9673E−05 |
| I: | 0.0000E+00 | 0.0000E+00 | 0.0000E+00 | 0.0000E+00 | 0.0000E+00 | 0.0000E+00 |
| J: | 0.0000E+00 | 0.0000E+00 | 0.0000E+00 | 0.0000E+00 | 0.0000E+00 | 0.0000E+00 |
| surface | 10 | 11 | 12 | 13 | 14 | 15 |
| K: | 9.5677E+01 | 9.8766E+01 | −1.6520E+01 | −8.5235E+00 | −6.9465E+00 | 2.2098E+01 |
| A: | 0.0000E+00 | 0.0000E+00 | 0.0000E+00 | 0.0000E+00 | 0.0000E+00 | 0.0000E+00 |
| B: | 2.7363E−04 | −1.6121E−02 | −3.6174E−02 | −6.0424E−02 | −6.0261E−03 | 2.0147E−02 |
| C: | −1.8898E−02 | 1.5470E−03 | 1.0569E−02 | 1.5570E−02 | −4.7691E−03 | −8.3123E−03 |
| D: | 1.2336E−02 | −2.0087E−03 | −3.2932E−03 | −3.8431E−03 | 1.0304E−03 | 1.5825E−03 |
| E: | −2.4641E−03 | 1.6300E−03 | 3.1553E−04 | 6.4253E−04 | −2.9407E−04 | −2.1353E−04 |
| F: | −3.2254E−05 | −5.5905E−04 | 7.9863E−05 | −4.7377E−05 | 6.0673E−05 | 1.8956E−05 |
| G: | 7.2646E−05 | 8.9289E−05 | −2.4323E−05 | 2.6925E−07 | −6.8987E−06 | −9.7668E−07 |
| H: | −6.8701E−06 | −4.9209E−06 | 1.8265E−06 | 7.9314E−08 | 3.1549E−07 | 2.1872E−08 |
| I: | 0.0000E+00 | 0.0000E+00 | −1.2824E−09 | 2.1901E−11 | 3.2421E−12 | −1.8490E−12 |
| J: | 0.0000E+00 | 0.0000E+00 | 1.1091E−10 | 4.0698E−12 | −8.0639E−12 | −1.8509E−13 |

| surface | 16 | 17 |
|---|---|---|
| K: | −6.8671E−01 | −1.0170E+02 |
| A: | 0.0000E+00 | 0.0000E+00 |
| B: | −2.0647E−02 | −2.3228E−02 |
| C: | 8.4148E−03 | 5.9144E−03 |
| D: | −1.0736E−03 | −9.0031E−04 |
| E: | 7.5752E−05 | 7.6760E−05 |
| F: | −3.0816E−06 | −3.6926E−06 |
| G: | 6.8002E−08 | 9.3969E−08 |
| H: | −6.2734E−10 | −9.8167E−10 |
| I: | 1.6979E−15 | 4.7273E−15 |
| J: | 2.7895E−16 | 2.1578E−16 |

The units of the radius of curvature, the thickness and the focal length in table 1 are expressed in mm, the surface numbers 0-20 represent the surfaces sequentially arranged from the object-side to the image-side along the optical axis, and the shading surface (i.e. surface 7) for allowing part of the light to pass through and part of the light shield, wherein the diameter of the shading surface is 1.56 mm.

In table 2, k represents the conic coefficient of the equation of the aspheric surface profiles, and A, B, C, D, E, F, G . . . : represent the high-order aspheric coefficients. The tables presented below for each embodiment are the corresponding schematic parameter and image plane curves, and the definitions of the tables are the same as Table 1 and Table 2 of the first embodiment. Therefore, an explanation in this regard will not be provided again.

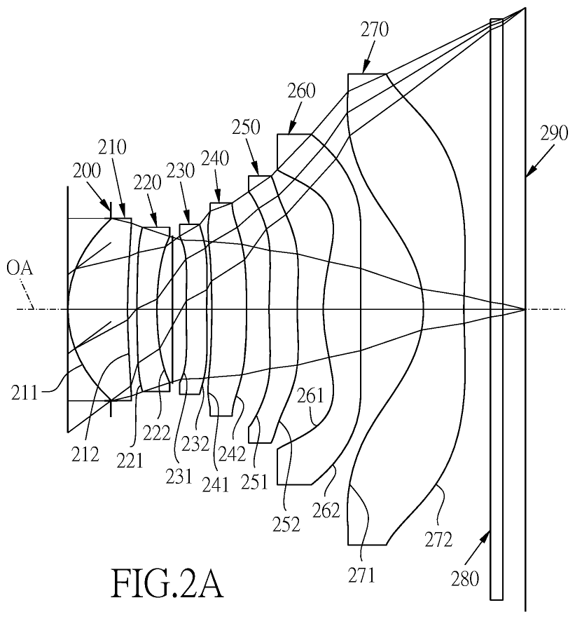

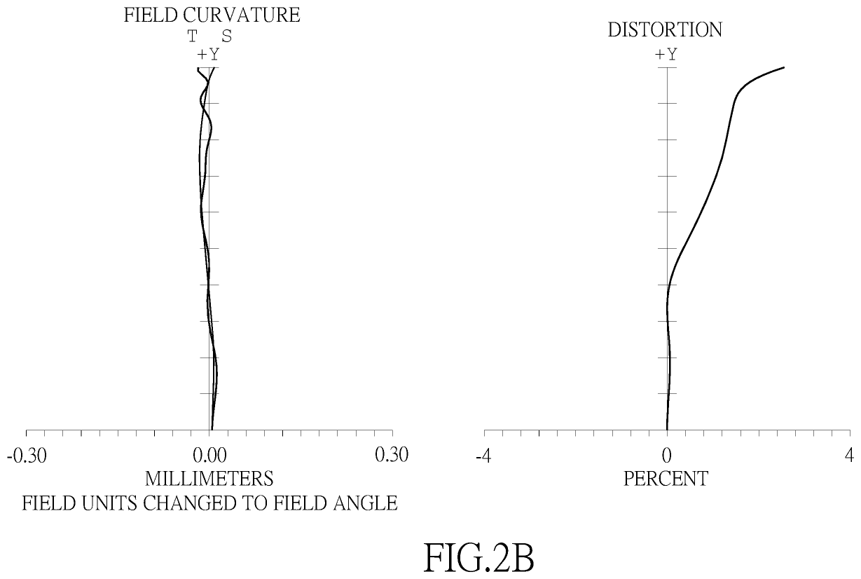

Referring to FIGS. 2A and 2B, FIG. 2A shows a seven-piece optical lens system in accordance with a second embodiment of the present invention, and FIG. 2B shows, in order from left to right, the image plane curve and the distortion curve of the second embodiment of the present invention. A seven-piece optical lens system in accordance with the second embodiment of the present invention comprises a stop 200 and a lens group. The lens group comprises, in order from an object side to an image side: a first lens element 210, a second lens element 220, a third lens element 230, a fourth lens element 240, a fifth lens element 250, a sixth lens element 260, a seventh lens element 270, an IR cut filter 280, and an image plane 290, wherein the seven-piece optical lens system has a total of seven lens elements with refractive power. The stop 200 is disposed between an image-side surface 212 of the first lens element 210 and an object to be imaged.

The first lens element 210 with a positive refractive power has an object-side surface 211 being convex near an optical axis OA and the image-side surface 212 being concave near the optical axis OA, the object-side surface 211 and the image-side surface 212 are aspheric, and the first lens element 210 is made of plastic material.

The second lens element 220 with a negative refractive power has an object-side surface 221 being convex near the optical axis OA and an image-side surface 222 being concave near the optical axis OA, the object-side surface 221 and the image-side surface 222 are aspheric, and the second lens element 220 is made of plastic material.

The third lens element 230 with a positive refractive power has an object-side surface 231 being convex near the optical axis OA and an image-side surface 232 being concave near the optical axis OA, the object-side surface 231 and the image-side surface 232 are aspheric, and the third lens element 230 is made of plastic material.

The fourth lens element 240 with a positive refractive power has an object-side surface 241 being concave near the optical axis OA and an image-side surface 242 being convex near the optical axis OA, the object-side surface 241 and the image-side surface 242 are aspheric, and the fourth lens element 240 is made of plastic material.

The fifth lens element 250 with a negative refractive power has an object-side surface 251 being convex near the optical axis OA and an image-side surface 252 being concave near the optical axis OA, the object-side surface 251 and the image-side surface 252 are aspheric and are provided with at least one inflection point, and the fifth lens element 250 is made of plastic material.

The sixth lens element 260 with a positive refractive power has an object-side surface 261 being convex near the optical axis OA and an image-side surface 262 being convex near the optical axis OA, the object-side surface 261 and the image-side surface 262 are aspheric and are provided with at least one inflection point, and the sixth lens element 260 is made of plastic material.

The seventh lens element 270 with a negative refractive power has an object-side surface 271 being concave near the optical axis OA and an image-side surface 272 being concave near the optical axis OA, the object-side surface 271 and the image-side surface 272 are aspheric and are provided with at least one inflection point, and the seventh lens element 270 is made of plastic material.

The IR cut filter 280 made of glass is located between the seventh lens element 270 and the image plane 290 and has no influence on the focal length of the seven-piece optical lens system.

The detailed optical data of the second embodiment is shown in table 3, and the aspheric surface data is shown in table 4.

TABLE 3
Embodiment 2
f(focal length) = 6.77 mm, Fno = 1.85, FOV = 82.2 deg.

| surface | | Curvature Radius | | Thickness | Material | Index | Abbe # | Focal length |
|---|---|---|---|---|---|---|---|---|
| 0 | object | infinity | | infinity | | | | |
| 1 | | infinity | | 0.736 | | | | |
| 2 | stop | infinity | | −0.736 | | | | |
| 3 | Lens 1 | 2.585 | (ASP) | 1.018 | plastic | 1.54 | 56 | 5.75 |
| 4 | | 12.600 | (ASP) | 0.156 | | | | |
| 5 | Lens 2 | 17.264 | (ASP) | 0.344 | plastic | 1.67 | 19.2 | −14.10 |
| 6 | | 6.100 | (ASP) | 0.270 | | | | |
| 7 | shading surface | infinity | | 0.233 | | | | |
| 8 | Lens 3 | 22.174 | (ASP) | 0.348 | plastic | 1.67 | 19.2 | 207.44 |
| 9 | | 26.160 | (ASP) | 0.091 | | | | |
| 10 | Lens 4 | −24.648 | (ASP) | 0.594 | plastic | 1.54 | 56 | 849.71 |
| 11 | | −23.604 | (ASP) | 0.383 | | | | |
| 12 | Lens 5 | 9.446 | (ASP) | 0.480 | plastic | 1.54 | 56 | −75.35 |
| 13 | | 7.545 | (ASP) | 0.449 | | | | |
| 14 | Lens 6 | 4.018 | (ASP) | 0.642 | plastic | 1.54 | 56 | 6.26 |
| 15 | | −21.597 | (ASP) | 1.068 | | | | |
| 16 | Lens 7 | −2.782 | (ASP) | 0.693 | plastic | 1.54 | 56 | −4.07 |
| 17 | | 12.043 | (ASP) | 0.455 | | | | |

| | | | | | | | |
|---|---|---|---|---|---|---|---|
| 18 | IR-filter | infinity | 0.210 | glass | 1.52 | 64.2 | — |
| 19 | | infinity | 0.387 | | | | |
| 20 | Image plane | infinity | — | | | | |

TABLE 4
Aspheric Coefficients

| surface | 3 | 4 | 5 | 6 | 8 | 9 |
|---|---|---|---|---|---|---|
| K: | −7.3984E−01 | 3.8699E+01 | 8.0920E+01 | −1.9073E+01 | 9.4197E+01 | 9.5956E+01 |
| A: | 0.0000E+00 | 0.0000E+00 | 0.0000E+00 | 0.0000E+00 | 0.0000E+00 | 0.0000E+00 |
| B: | 5.6894E−03 | −1.7872E−02 | −2.4900E−02 | 1.1505E−03 | −2.4484E−02 | −1.3415E−02 |
| C: | 5.3135E−04 | 8.4496E−03 | 2.1097E−02 | 1.2297E−02 | −1.0454E−02 | −1.7021E−02 |
| D: | 5.0610E−04 | −3.9210E−03 | −9.1937E−03 | −5.0458E−04 | 1.5083E−02 | 1.4265E−02 |
| E: | −4.5443E−04 | 1.7328E−03 | 3.2627E−03 | −4.4212E−03 | −1.4941E−02 | −7.5617E−03 |
| F: | 2.0123E−04 | −7.2537E−04 | −1.0516E−03 | 3.3743E−03 | 7.7356E−03 | 2.4696E−03 |
| G: | −4.0822E−05 | 1.7308E−04 | 2.4580E−04 | −1.1366E−03 | −2.2827E−03 | −4.6794E−04 |
| H: | 2.0553E−06 | −1.6898E−05 | −2.2872E−05 | 1.6052E−04 | 2.9967E−04 | 4.5932E−05 |
| I: | 0.0000E+00 | 0.0000E+00 | 0.0000E+00 | 0.0000E+00 | 0.0000E+00 | 0.0000E+00 |
| J: | 0.0000E+00 | 0.0000E+00 | 0.0000E+00 | 0.0000E+00 | 0.0000E+00 | 0.0000E+00 |
| surface | 10 | 11 | 12 | 13 | 14 | 15 |
| K: | −1.5863E+01 | 9.9900E+01 | −2.3490E+01 | −6.6568E+00 | −1.2997E+01 | 1.7583E+01 |
| A: | 0.0000E+00 | 0.0000E+00 | 0.0000E+00 | 0.0000E+00 | 0.0000E+00 | 0.0000E+00 |
| B: | 2.5192E−03 | −1.3229E−02 | −4.4122E−02 | −6.9391E−02 | 6.0194E−03 | 2.5481E−02 |
| C: | −1.5359E−02 | 9.2592E−04 | 1.7960E−02 | 1.9659E−02 | −1.1820E−02 | −9.8281E−03 |
| D: | 8.3956E−03 | −1.4863E−03 | −6.1276E−03 | −3.3245E−03 | 4.1905E−03 | 1.9403E−03 |
| E: | −1.4711E−03 | 6.2279E−04 | 8.4220E−04 | −9.6312E−05 | −1.1336E−03 | −2.9094E−04 |
| F: | 8.7496E−05 | −5.6260E−05 | 2.0861E−05 | 1.5902E−04 | 1.8784E−04 | 2.9334E−05 |
| G: | 0.0000E+00 | 0.0000E+00 | −1.1829E−05 | −2.4004E−05 | −1.7598E−05 | −1.6314E−06 |
| H: | 0.0000E+00 | 0.0000E+00 | 4.4700E−07 | 1.1247E−06 | 7.1215E−07 | 3.6897E−08 |
| I: | 0.0000E+00 | 0.0000E+00 | 0.0000E+00 | 0.0000E+00 | 0.0000E+00 | 0.0000E+00 |
| J: | 0.0000E+00 | 0.0000E+00 | 0.0000E+00 | 0.0000E+00 | 0.0000E+00 | 0.0000E+00 |

| surface | 16 | 17 |
|---|---|---|
| K: | −6.7483E−01 | −9.9900E+01 |
| A: | 0.0000E+00 | 0.0000E+00 |
| B: | −8.5525E−03 | −1.6938E−02 |
| C: | 4.1611E−03 | 3.6844E−03 |
| D: | −3.6706E−04 | −5.2809E−04 |
| E: | 1.2568E−05 | 4.4194E−05 |
| F: | 7.7476E−08 | −2.1685E−06 |
| G: | −1.5563E−08 | 5.7828E−08 |
| H: | 2.9152E−10 | −6.4032E−10 |
| I: | 0.0000E+00 | 0.0000E+00 |
| J: | 0.0000E+00 | 0.0000E+00 |

In the second embodiment, the equation of the aspheric surface profiles of the aforementioned lens elements is the same as the equation of the first embodiment. Also, the definitions of these parameters shown in the following table are the same as those stated in the first embodiment with corresponding values for the second embodiment, so an explanation in this regard will not be provided again. It is noted that the diameter of the shading surface in the second embodiment is 1.482 mm.

Moreover, these parameters can be calculated from Table 3 and Table 4 as the following values and satisfy the following conditions:

Embodiment 2

| | | | |
|---|---|---|---|
| f[mm] | 6.77 | R13*R14/f7[mm] | 8.232 |
| Fno | 1.86 | (CT1 + CT2 + CT3)/TL | 0.219 |
| FOV[deg.] | 82.17 | (TL − BFL)/f1 | 1.178 |
| f1/R2 | 0.456 | f5/(R9*R10) [mm⁻¹] | −1.057 |
| f2/f7 | 3.464 | TL/f | 1.154 |
| f34/(f1*f2) [mm⁻¹] | −2.075 | IMH/TL | 0.774 |
| f1/f2 | −0.408 | V1 − V2 | 36.800 |
| R1/R2 | 0.205 | f/(R13*R14) [mm⁻¹] | −0.228 |

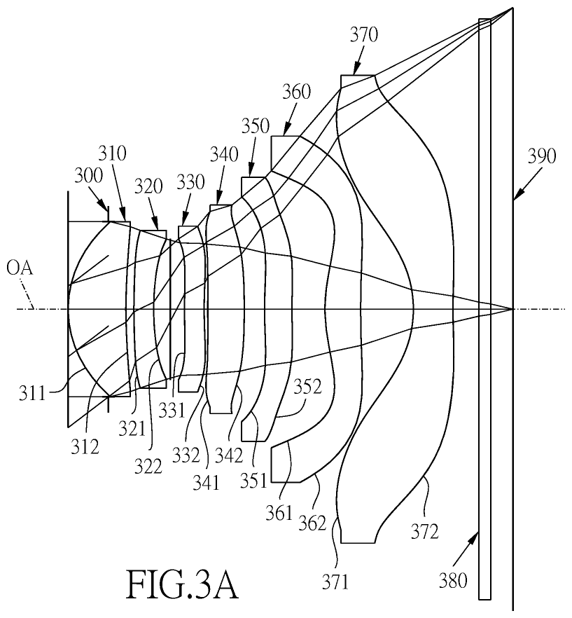

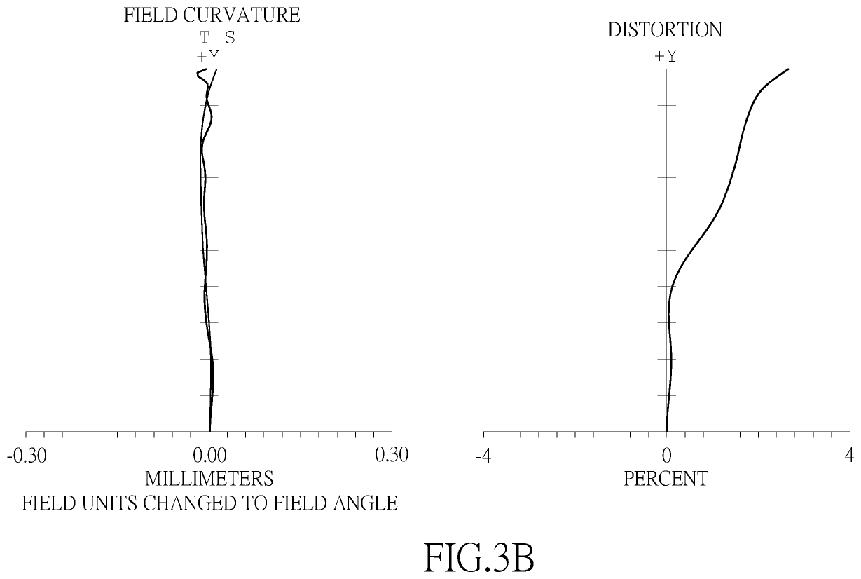

Referring to FIGS. 3A and 3B, FIG. 3A shows a seven-piece optical lens system in accordance with a third embodiment of the present invention, and FIG. 3B shows, in order from left to right, the image plane curve and the distortion curve of the third embodiment of the present invention. A seven-piece optical lens system in accordance with the third embodiment of the present invention comprises a stop 300 and a lens group. The lens group comprises, in order from an object side to an image side: a first lens element 310, a second lens element 320, a third lens element 330, a fourth lens element 340, a fifth lens element 350, a sixth lens element 360, a seventh lens element 370, an IR cut filter 380, and an image plane 390, wherein the seven-piece optical lens system has a total of seven lens elements with refractive power. The stop 300 is disposed between an image-side surface 312 of the first lens element 310 and an object to be imaged.

The first lens element 310 with a positive refractive power has an object-side surface 311 being convex near an optical axis OA and the image-side surface 312 being concave near the optical axis OA, the object-side surface 311 and the image-side surface 312 are aspheric, and the first lens element 310 is made of plastic material.

The second lens element 320 with a negative refractive power has an object-side surface 321 being convex near the optical axis OA and an image-side surface 322 being concave near the optical axis OA, the object-side surface 321 and the image-side surface 322 are aspheric, and the second lens element 320 is made of plastic material.

The third lens element 330 with a negative refractive power has an object-side surface 331 being convex near the optical axis OA and an image-side surface 332 being concave near the optical axis OA, the object-side surface 331 and the image-side surface 332 are aspheric, and the third lens element 330 is made of plastic material.

The fourth lens element 340 with a positive refractive power has an object-side surface 341 being concave near the optical axis OA and an image-side surface 342 being convex near the optical axis OA, the object-side surface 341 and the image-side surface 342 are aspheric, and the fourth lens element 340 is made of plastic material.

The fifth lens element 350 with a positive refractive power has an object-side surface 351 being convex near the optical axis OA and an image-side surface 352 being concave near the optical axis OA, the object-side surface 351 and the image-side surface 352 are aspheric and are provided with at least one inflection point, and the fifth lens element 350 is made of plastic material.

The sixth lens element 360 with a positive refractive power has an object-side surface 361 being convex near the optical axis OA and an image-side surface 362 being concave near the optical axis OA, the object-side surface 361 and the image-side surface 362 are aspheric and are provided with at least one inflection point, and the sixth lens element 360 is made of plastic material.

The seventh lens element 370 with a negative refractive power has an object-side surface 371 being concave near the optical axis OA and an image-side surface 372 being concave near the optical axis OA, the object-side surface 371 and the image-side surface 372 are aspheric and are provided with at least one inflection point, and the seventh lens element 370 is made of plastic material.

The IR cut filter 380 made of glass is located between the seventh lens element 370 and the image plane 390 and has no influence on the focal length of the seven-piece optical lens system.

The detailed optical data of the third embodiment is shown in table 5, and the aspheric surface data is shown in table 6.

TABLE 5
Embodiment 3
f(focal length) = 6.77 mm, Fno = 1.88, FOV = 81.9 deg.

| surface | | Curvature Radius | | Thickness | Material | Index | Abbe # | Focal length |
|---|---|---|---|---|---|---|---|---|
| 0 | object | infinity | | infinity | | | | |
| 1 | | infinity | | 0.707 | | | | |
| 2 | stop | infinity | | −0.707 | | | | |
| 3 | Lens 1 | 2.558 | (ASP) | 1.010 | plastic | 1.54 | 56 | 5.77 |
| 4 | | 11.688 | (ASP) | 0.140 | | | | |
| 5 | Lens 2 | 16.025 | (ASP) | 0.349 | plastic | 1.67 | 19.2 | −15.17 |
| 6 | | 6.206 | (ASP) | 0.292 | | | | |
| 7 | shading surface | infinity | | 0.248 | | | | |
| 8 | Lens 3 | 16.809 | (ASP) | 0.346 | plastic | 1.67 | 19.2 | −47.57 |
| 9 | | 10.955 | (ASP) | 0.062 | | | | |
| 10 | Lens 4 | −278.436 | (ASP) | 0.639 | plastic | 1.54 | 56 | 45.37 |
| 11 | | −22.775 | (ASP) | 0.354 | | | | |
| 12 | Lens 5 | 9.266 | (ASP) | 0.480 | plastic | 1.59 | 28.4 | 81.87 |
| 13 | | 11.237 | (ASP) | 0.583 | | | | |
| 14 | Lens 6 | 3.710 | (ASP) | 0.627 | plastic | 1.54 | 56 | 7.59 |
| 15 | | 33.241 | (ASP) | 0.922 | | | | |
| 16 | Lens 7 | −2.794 | (ASP) | 0.695 | plastic | 1.54 | 56 | −4.17 |
| 17 | | 13.343 | (ASP) | 0.453 | | | | |

| | | | | | | | |
|---|---|---|---|---|---|---|---|
| 18 | IR-filter | infinity | 0.210 | glass | 1.52 | 64.2 | — |
| 19 | | infinity | 0.385 | | | | |
| 20 | Image plane | infinity | — | | | | |

TABLE 6
Aspheric Coefficients

| surface | 3 | 4 | 5 | 6 | 8 | 9 |
|---|---|---|---|---|---|---|
| K: | −7.1450E−01 | 3.4229E+01 | 6.9777E+01 | −1.4348E+01 | −4.8203E+01 | −6.3864E+01 |
| A: | 0.0000E+00 | 0.0000E+00 | 0.0000E+00 | 0.0000E+00 | 0.0000E+00 | 0.0000E+00 |
| B: | 5.4263E−03 | −1.6264E−02 | −1.9186E−02 | 3.7616E−03 | −2.5433E−02 | 4.6468E−04 |
| C: | 1.4880E−03 | 7.4741E−03 | 1.6451E−02 | 9.2198E−03 | −1.6212E−02 | −4.0023E−02 |
| D: | −7.0608E−04 | −4.0076E−03 | −7.3276E−03 | 1.1733E−03 | 2.2342E−02 | 2.9829E−02 |
| E: | 4.1593E−04 | 2.1734E−03 | 2.9775E−03 | −4.8127E−03 | −1.9622E−02 | −1.5026E−02 |
| F: | −1.3238E−04 | −1.0178E−03 | −1.1271E−03 | 3.4590E−03 | 9.2336E−03 | 4.8580E−03 |
| G: | 2.4428E−05 | 2.6045E−04 | 2.9321E−04 | −1.1544E−03 | −2.4328E−03 | −8.8746E−04 |
| H: | −2.9872E−06 | −2.6830E−05 | −2.9927E−05 | 1.6669E−04 | 2.8930E−04 | 7.3935E−05 |
| I: | 0.0000E+00 | 0.0000E+00 | 0.0000E+00 | 0.0000E+00 | 0.0000E+00 | 0.0000E+00 |
| J: | 0.0000E+00 | 0.0000E+00 | 0.0000E+00 | 0.0000E+00 | 0.0000E+00 | 0.0000E+00 |
| surface | 10 | 11 | 12 | 13 | 14 | 15 |
| K: | 9.9900E+01 | 9.4438E+01 | −3.3402E+01 | 5.5330E+00 | −5.4705E+00 | −4.0937E+01 |
| A: | 0.0000E+00 | 0.0000E+00 | 0.0000E+00 | 0.0000E+00 | 0.0000E+00 | 0.0000E+00 |
| B: | 1.8895E−02 | −1.7512E−02 | −4.4654E−02 | −6.6449E−02 | −1.6759E−02 | 9.7733E−03 |
| C: | −3.6391E−02 | 6.6759E−03 | 2.2756E−02 | 2.6202E−02 | −1.0110E−03 | −8.3749E−03 |
| D: | 1.9083E−02 | −7.7515E−03 | −1.2681E−02 | −9.6587E−03 | 1.0579E−04 | 2.2601E−03 |
| E: | −4.3861E−03 | 4.7551E−03 | 4.2506E−03 | 2.4694E−03 | −5.9961E−05 | −3.6921E−04 |
| F: | 4.9659E−04 | −1.4381E−03 | −8.1961E−04 | −3.5752E−04 | 2.0028E−05 | 3.5037E−05 |
| G: | −2.0230E−05 | 2.2117E−04 | 8.6365E−05 | 2.6554E−05 | −3.4340E−06 | −1.7642E−06 |
| H: | −4.4872E−07 | −1.3398E−05 | −3.9924E−06 | −8.0217E−07 | 2.0381E−07 | 3.6227E−08 |
| I: | 0.0000E+00 | 0.0000E+00 | 0.0000E+00 | 0.0000E+00 | 0.0000E+00 | 0.0000E+00 |
| J: | 0.0000E+00 | 0.0000E+00 | 0.0000E+00 | 0.0000E+00 | 0.0000E+00 | 0.0000E+00 |

| surface | 16 | 17 |
|---|---|---|
| K: | −6.7789E−01 | −9.9900E+01 |
| A: | 0.0000E+00 | 0.0000E+00 |
| B: | −1.7641E−02 | −2.2076E−02 |
| C: | 7.3692E−03 | 5.3660E−03 |
| D: | −8.8106E−04 | −7.8158E−04 |
| E: | 5.6770E−05 | 6.4103E−05 |
| F: | −2.0399E−06 | −3.0274E−06 |
| G: | 3.7977E−08 | 7.7502E−08 |
| H: | −2.6892E−10 | −8.2916E−10 |
| I: | 0.0000E+00 | 0.0000E+00 |
| J: | 0.0000E+00 | 0.0000E+00 |

In the third embodiment, the equation of the aspheric surface profiles of the aforementioned lens elements is the same as the equation of the first embodiment. Also, the definitions of these parameters shown in the following table are the same as those stated in the first embodiment with corresponding values for the third embodiment, so an explanation in this regard will not be provided again. It is noted that the diameter of the shading surface in the third embodiment is 1.455 mm.

Moreover, these parameters can be calculated from Table 5 and Table 6 as the following values and satisfy the following conditions:

Embodiment 3

| | | | |
|---|---|---|---|
| f[mm] | 6.77 | R13*R14/f7[mm] | 8.949 |
| Fno | 1.88 | (CT1 + CT2 + CT3)/TL | 0.219 |
| FOV[deg.] | 81.92 | (TL − BFL)/f1 | 1.170 |
| f1/R2 | 0.494 | f5/(R9*R10) [mm⁻¹] | 0.786 |
| f2/f7 | 3.641 | TL/f | 1.152 |
| f34/(f1*f2) [mm⁻¹] | −10.646 | IMH/TL | 0.772 |
| f1/f2 | −0.380 | V1 − V2 | 36.800 |
| R1/R2 | 0.219 | f/(R13*R14) [mm⁻¹] | −0.182 |

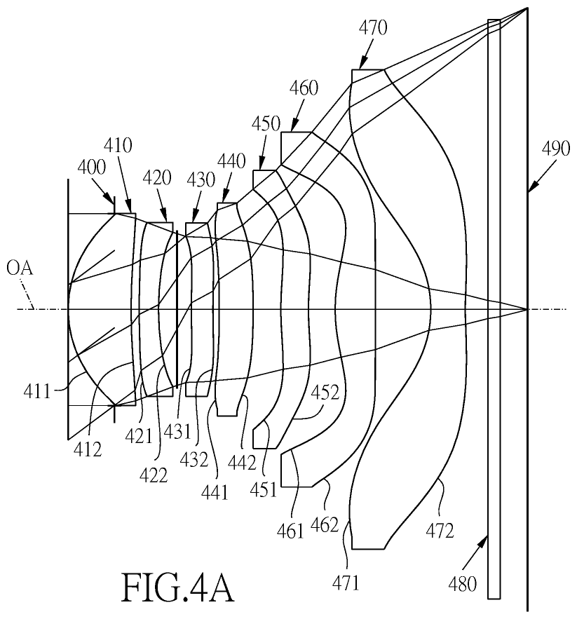

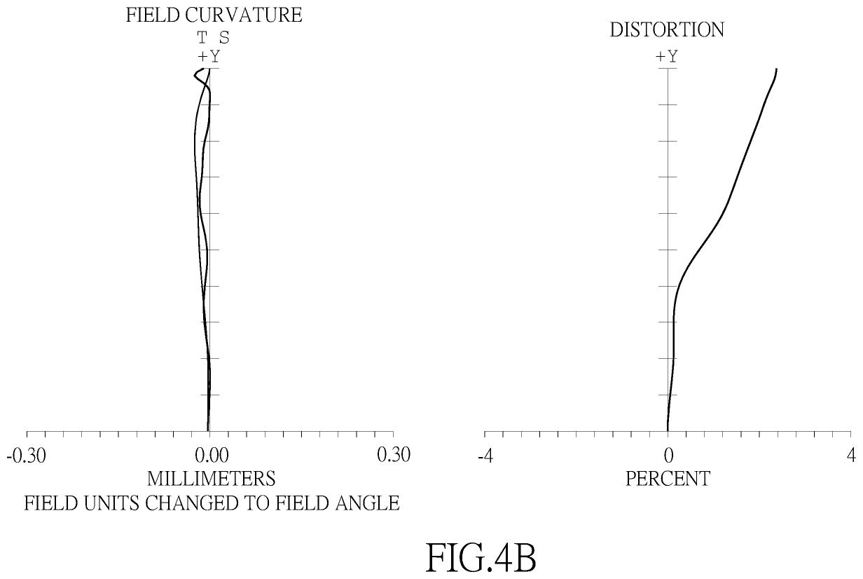

Referring to FIGS. 4A and 4B, FIG. 4A shows a seven-piece optical lens system in accordance with a fourth embodiment of the present invention, and FIG. 4B shows, in order from left to right, the image plane curve and the distortion curve of the fourth embodiment of the present invention. A seven-piece optical lens system in accordance with the fourth embodiment of the present invention comprises a stop 400 and a lens group. The lens group comprises, in order from an object side to an image side: a first lens element 410, a second lens element 420, a third lens element 430, a fourth lens element 440, a fifth lens element 450, a sixth lens element 460, a seventh lens element 470, an IR cut filter 480, and an image plane 490, wherein the seven-piece optical lens system has a total of seven lens elements with refractive power. The stop 400 is disposed between an image-side surface 412 of the first lens element 410 and an object to be imaged.

The first lens element 410 with a positive refractive power has an object-side surface 411 being convex near an optical axis OA and the image-side surface 412 being concave near the optical axis OA, the object-side surface 411 and the image-side surface 412 are aspheric, and the first lens element 410 is made of plastic material.

The second lens element 420 with a negative refractive power has an object-side surface 421 being convex near the optical axis OA and an image-side surface 422 being concave near the optical axis OA, the object-side surface 421 and the image-side surface 422 are aspheric, and the second lens element 420 is made of plastic material.

The third lens element 430 with a negative refractive power has an object-side surface 431 being convex near the optical axis OA and an image-side surface 432 being concave near the optical axis OA, the object-side surface 431 and the image-side surface 432 are aspheric, and the third lens element 430 is made of plastic material.

The fourth lens element 440 with a positive refractive power has an object-side surface 441 being concave near the optical axis OA and an image-side surface 442 being convex near the optical axis OA, the object-side surface 441 and the image-side surface 442 are aspheric, and the fourth lens element 440 is made of plastic material.

The fifth lens element 450 with a negative refractive power has an object-side surface 451 being convex near the optical axis OA and an image-side surface 452 being concave near the optical axis OA, the object-side surface 451 and the image-side surface 452 are aspheric and are provided with at least one inflection point, and the fifth lens element 450 is made of plastic material.

The sixth lens element 460 with a positive refractive power has an object-side surface 461 being convex near the optical axis OA and an image-side surface 462 being convex near the optical axis OA, the object-side surface 461 and the image-side surface 462 are aspheric and are provided with at least one inflection point, and the sixth lens element 460 is made of plastic material.

The seventh lens element 470 with a negative refractive power has an object-side surface 471 being concave near the optical axis OA and an image-side surface 472 being concave near the optical axis OA, the object-side surface 471 and the image-side surface 472 are aspheric and are provided with at least one inflection point, and the seventh lens element 470 is made of plastic material.

The IR cut filter 480 made of glass is located between the seventh lens element 470 and the image plane 490 and has no influence on the focal length of the seven-piece optical lens system.

The detailed optical data of the fourth embodiment is shown in table 7, and the aspheric surface data is shown in table 8.

TABLE 7
Embodiment 4
f(focal length) = 6.70 mm, Fno = 1.75, FOV = 82.5 deg.

| surface | | Curvature Radius | | Thickness | Material | Index | Abbe # | Focal length |
|---|---|---|---|---|---|---|---|---|
| 0 | object | infinity | | infinity | | | | |
| 1 | | infinity | | 0.787 | | | | |
| 2 | stop | infinity | | −0.787 | | | | |
| 3 | Lens 1 | 2.620 | (ASP) | 1.072 | plastic | 1.54 | 56 | 5.78 |
| 4 | | 13.181 | (ASP) | 0.134 | | | | |
| 5 | Lens 2 | 18.088 | (ASP) | 0.329 | plastic | 1.67 | 19.2 | −14.94 |
| 6 | | 6.442 | (ASP) | 0.317 | | | | |
| 7 | shading surface | infinity | | 0.239 | | | | |
| 8 | Lens 3 | 19.926 | (ASP) | 0.367 | plastic | 1.67 | 19.2 | −717.86 |
| 9 | | 19.000 | (ASP) | 0.110 | | | | |
| 10 | Lens 4 | −31.321 | (ASP) | 0.574 | plastic | 1.54 | 56 | 143.30 |
| 11 | | −22.515 | (ASP) | 0.471 | | | | |
| 12 | Lens 5 | 6.941 | (ASP) | 0.470 | plastic | 1.54 | 56 | −101.75 |
| 13 | | 6.023 | (ASP) | 0.450 | | | | |
| 14 | Lens 6 | 3.874 | (ASP) | 0.689 | plastic | 1.54 | 56 | 6.30 |
| 15 | | −28.791 | (ASP) | 0.935 | | | | |
| 16 | Lens 7 | −2.839 | (ASP) | 0.591 | plastic | 1.54 | 56 | −4.05 |
| 17 | | 10.727 | (ASP) | 0.380 | | | | |

| | | | | | | | |
|---|---|---|---|---|---|---|---|
| 18 | IR-filter | infinity | 0.210 | glass | 1.52 | 64.2 | — |
| 19 | | infinity | 0.465 | | | | |
| 20 | Image plane | infinity | — | | | | |

TABLE 8
Aspheric Coefficients

| surface | 3 | 4 | 5 | 6 | 8 | 9 |
|---|---|---|---|---|---|---|
| K: | −7.6391E−01 | 3.9532E+01 | 8.7801E+01 | −1.8742E+01 | 7.8781E+01 | 9.8102E+01 |
| A: | 0.0000E+00 | 0.0000E+00 | 0.0000E+00 | 0.0000E+00 | 0.0000E+00 | 0.0000E+00 |
| B: | 5.9670E−03 | −1.4889E−02 | −1.8935E−02 | 3.7996E−03 | −2.1351E−02 | −1.2640E−02 |
| C: | −4.8710E−04 | 7.7907E−03 | 1.7026E−02 | 9.0940E−03 | −1.4255E−02 | −2.3790E−02 |
| D: | 1.6070E−03 | −4.4374E−03 | −8.4982E−03 | −1.1526E−03 | 1.6108E−02 | 2.0460E−02 |
| E: | −1.1190E−03 | 2.1715E−03 | 3.5959E−03 | −2.6123E−03 | −1.2574E−02 | −1.0437E−02 |
| F: | 4.1974E−04 | −8.4098E−04 | −1.2163E−03 | 2.3121E−03 | 5.2214E−03 | 3.3752E−03 |
| G: | −7.8095E−05 | 1.8182E−04 | 2.6662E−04 | −8.0092E−04 | −1.1658E−03 | −6.1929E−04 |
| H: | 4.8444E−06 | −1.6118E−05 | −2.3445E−05 | 1.1215E−04 | 1.1446E−04 | 4.9750E−05 |
| I: | 0.0000E+00 | 0.0000E+00 | 0.0000E+00 | 0.0000E+00 | 0.0000E+00 | 0.0000E+00 |
| J: | 0.0000E+00 | 0.0000E+00 | 0.0000E+00 | 0.0000E+00 | 0.0000E+00 | 0.0000E+00 |
| surface | 10 | 11 | 12 | 13 | 14 | 15 |
| K: | 9.6431E+01 | 9.8115E+01 | −1.6849E+01 | −8.0180E+00 | −6.8200E+00 | 4.1034E+01 |
| A: | 0.0000E+00 | 0.0000E+00 | 0.0000E+00 | 0.0000E+00 | 0.0000E+00 | 0.0000E+00 |
| B: | 2.1818E−04 | −1.6112E−02 | −3.6374E−02 | −6.0377E−02 | −6.0206E−03 | 2.0100E−02 |
| C: | −1.8897E−02 | 1.5500E−03 | 1.0561E−02 | 1.5565E−02 | −4.7640E−03 | −8.3147E−03 |
| D: | 1.2342E−02 | −2.0075E−03 | −3.2921E−03 | −3.8436E−03 | 1.0284E−03 | 1.5840E−03 |
| E: | −2.4621E−03 | 1.6294E−03 | 3.1579E−04 | 6.4246E−04 | −2.9405E−04 | −2.1350E−04 |
| F: | −3.1929E−05 | −5.5800E−04 | 7.9870E−05 | −4.7370E−05 | 6.0713E−05 | 1.8956E−05 |
| G: | 7.2735E−05 | 8.9230E−05 | −2.4292E−05 | 2.6902E−07 | −6.9021E−06 | −9.7669E−07 |
| H: | −6.8495E−06 | −4.9051E−06 | 1.8340E−06 | 7.9242E−08 | 3.1586E−07 | 2.1866E−08 |
| I: | 0.0000E+00 | 0.0000E+00 | 0.0000E+00 | 0.0000E+00 | 0.0000E+00 | 0.0000E+00 |
| J: | 0.0000E+00 | 0.0000E+00 | 0.0000E+00 | 0.0000E+00 | 0.0000E+00 | 0.0000E+00 |

| surface | 16 | 17 |
|---|---|---|
| K: | −6.8752E−01 | −1.0546E+02 |
| A: | 0.0000E+00 | 0.0000E+00 |
| B: | −2.0657E−02 | −2.3255E−02 |
| C: | 8.4146E−03 | 5.9143E−03 |
| D: | −1.0736E−03 | −9.0021E−04 |
| E: | 7.5752E−05 | 7.6761E−05 |
| F: | −3.0817E−06 | −3.6926E−06 |
| G: | 6.8004E−08 | 9.3971E−08 |
| H: | −6.2755E−10 | −9.8176E−10 |
| I: | 0.0000E+00 | 0.0000E+00 |
| J: | 0.0000E+00 | 0.0000E+00 |

In the fourth embodiment, the equation of the aspheric surface profiles of the aforementioned lens elements is the same as the equation of the first embodiment. Also, the definitions of these parameters shown in the following table are the same as those stated in the first embodiment with corresponding values for the fourth embodiment, so an explanation in this regard will not be provided again. It is noted that the diameter of the shading surface in the fourth embodiment is 1.574 mm.

Moreover, these parameters can be calculated from Table 7 and Table 8 as the following values and satisfy the following conditions:

Embodiment 4

| | | | |
|---|---|---|---|
| f[mm] | 6.70 | R13*R14/f7[mm] | 7.524 |
| Fno | 1.75 | (CT1 + CT2 + CT3)/TL | 0.227 |
| FOV[deg.] | 82.46 | (TL − BFL)/f1 | 1.168 |
| f1/R2 | 0.438 | f5/(R9*R10) [mm⁻¹] | −2.434 |
| f2/f7 | 3.691 | TL/f | 1.165 |
| f34/(f1*f2) [mm⁻¹] | −2.088 | IMH/TL | 0.771 |
| f1/f2 | −0.387 | V1 − V2 | 36.800 |
| R1/R2 | 0.199 | f/(R13*R14) [mm⁻¹] | −0.220 |

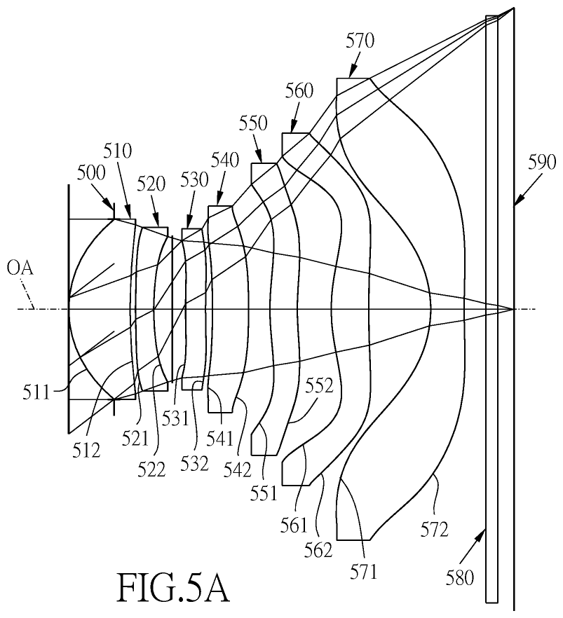

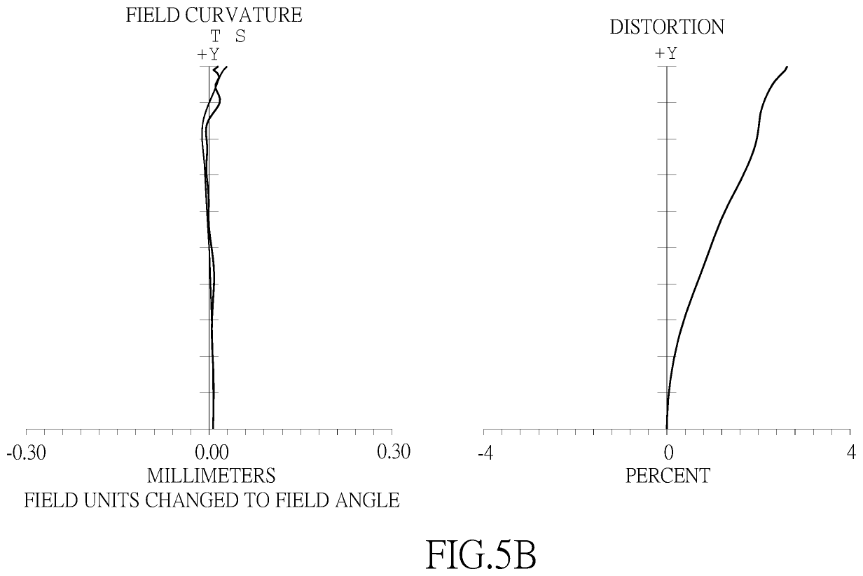

Referring to FIGS. 5A and 5B, FIG. 5A shows a seven-piece optical lens system in accordance with a fifth embodiment of the present invention, and FIG. 5B shows, in order from left to right, the image plane curve and the distortion curve of the fifth embodiment of the present invention. A seven-piece optical lens system in accordance with the fifth embodiment of the present invention comprises a stop 500 and a lens group. The lens group comprises, in order from an object side to an image side: a first lens element 510, a second lens element 520, a third lens element 530, a fourth lens element 540, a fifth lens element 550, a sixth lens element 560, a seventh lens element 570, an IR cut filter 580, and an image plane 590, wherein the seven-piece optical lens system has a total of seven lens elements with refractive power. The stop 500 is disposed between an image-side surface 512 of the first lens element 510 and an object to be imaged.

The first lens element 510 with a positive refractive power has an object-side surface 511 being convex near an optical axis OA and the image-side surface 512 being concave near the optical axis OA, the object-side surface 511 and the image-side surface 512 are aspheric, and the first lens element 510 is made of plastic material.

The second lens element 520 with a negative refractive power has an object-side surface 521 being convex near the optical axis OA and an image-side surface 522 being concave near the optical axis OA, the object-side surface 521 and the image-side surface 522 are aspheric, and the second lens element 520 is made of plastic material.

The third lens element 530 with a negative refractive power has an object-side surface 531 being convex near the optical axis OA and an image-side surface 532 being concave near the optical axis OA, the object-side surface 531 and the image-side surface 532 are aspheric, and the third lens element 530 is made of plastic material.

The fourth lens element 540 with a positive refractive power has an object-side surface 541 being concave near the optical axis OA and an image-side surface 542 being convex near the optical axis OA, the object-side surface 541 and the image-side surface 542 are aspheric, and the fourth lens element 540 is made of plastic material.

The fifth lens element 550 with a positive refractive power has an object-side surface 551 being convex near the optical axis OA and an image-side surface 552 being concave near the optical axis OA, the object-side surface 551 and the image-side surface 552 are aspheric and are provided with at least one inflection point, and the fifth lens element 550 is made of plastic material.

The sixth lens element 560 with a positive refractive power has an object-side surface 561 being convex near the optical axis OA and an image-side surface 562 being concave near the optical axis OA, the object-side surface 561 and the image-side surface 562 are aspheric and are provided with at least one inflection point, and the sixth lens element 560 is made of plastic material.

The seventh lens element 570 with a negative refractive power has an object-side surface 571 being concave near the optical axis OA and an image-side surface 572 being concave near the optical axis OA, the object-side surface 571 and the image-side surface 572 are aspheric and are provided with at least one inflection point, and the seventh lens element 570 is made of plastic material.

The IR cut filter 580 made of glass is located between the seventh lens element 570 and the image plane 590 and has no influence on the focal length of the seven-piece optical lens system.

The detailed optical data of the fifth embodiment is shown in table 9, and the aspheric surface data is shown in table 10.

TABLE 9
Embodiment 5
f(focal length) = 6.74 mm, Fno = 1.82, FOV = 83.8 deg.

| surface | | Curvature Radius | | Thickness | Material | Index | Abbe # | Focal length |
|---|---|---|---|---|---|---|---|---|
| 0 | object | infinity | | infinity | | | | |
| 1 | | infinity | | 0.792 | | | | |
| 2 | stop | infinity | | −0.792 | | | | |
| 3 | Lens 1 | 2.561 | (ASP) | 1.074 | plastic | 1.54 | 56 | 5.75 |
| 4 | | 11.831 | (ASP) | 0.097 | | | | |
| 5 | Lens 2 | 17.637 | (ASP) | 0.320 | plastic | 1.67 | 19.2 | −15.18 |
| 6 | | 6.449 | (ASP) | 0.320 | | | | |
| 7 | shading surface | infinity | | 0.237 | | | | |
| 8 | Lens 3 | 18.826 | (ASP) | 0.349 | plastic | 1.67 | 19.2 | −169.97 |
| 9 | | 16.059 | (ASP) | 0.121 | | | | |
| 10 | Lens 4 | −23.360 | (ASP) | 0.631 | plastic | 1.53 | 55.6 | 679.56 |
| 11 | | −22.161 | (ASP) | 0.374 | | | | |
| 12 | Lens 5 | 5.169 | (ASP) | 0.477 | plastic | 1.54 | 56 | 66.71 |
| 13 | | 5.827 | (ASP) | 0.596 | | | | |
| 14 | Lens 6 | 4.224 | (ASP) | 0.656 | plastic | 1.54 | 56 | 8.50 |
| 15 | | 44.191 | (ASP) | 1.087 | | | | |
| 16 | Lens 7 | −2.808 | (ASP) | 0.584 | plastic | 1.54 | 56 | −4.41 |
| 17 | | 18.284 | (ASP) | 0.380 | | | | |

| | | | | | | | |
|---|---|---|---|---|---|---|---|
| 18 | IR-filter | infinity | 0.210 | glass | 1.52 | 64.2 | — |
| 19 | | infinity | 0.284 | | | | |
| 20 | Image plane | infinity | — | | | | |

TABLE 10
Aspheric Coefficients

| surface | 3 | 4 | 5 | 6 | 8 | 9 |
|---|---|---|---|---|---|---|
| K: | −6.5365E−01 | 3.5634E+01 | 7.0931E+01 | −1.6097E+01 | 9.3012E+01 | 6.7086E+01 |
| A: | 0.0000E+00 | 0.0000E+00 | 0.0000E+00 | 0.0000E+00 | 0.0000E+00 | 0.0000E+00 |
| B: | 5.4259E−03 | −2.0250E−02 | −2.2244E−02 | 1.9338E−03 | −2.9446E−02 | −2.4781E−02 |
| C: | 1.1319E−03 | 1.3501E−02 | 2.3023E−02 | 1.5549E−02 | −3.5837E−03 | −7.4722E−03 |
| D: | −3.4663E−04 | −8.5003E−03 | −1.2792E−02 | −9.6282E−03 | 2.9442E−03 | 5.6881E−03 |
| E: | 2.9216E−04 | 4.7842E−03 | 6.0875E−03 | 4.9531E−03 | −1.7816E−03 | −2.7201E−03 |
| F: | −1.2354E−04 | −2.0481E−03 | −2.2771E−03 | −1.6084E−03 | 2.9605E−04 | 1.2267E−03 |
| G: | 3.1680E−05 | 4.9078E−04 | 5.3498E−04 | 2.7003E−04 | 6.4958E−05 | −2.9386E−04 |
| H: | −4.1022E−06 | −4.8291E−05 | −5.1375E−05 | 1.5106E−07 | −1.4349E−05 | 2.7542E−05 |
| I: | 0.0000E+00 | 0.0000E+00 | 0.0000E+00 | 0.0000E+00 | 0.0000E+00 | 0.0000E+00 |
| J: | 0.0000E+00 | 0.0000E+00 | 0.0000E+00 | 0.0000E+00 | 0.0000E+00 | 0.0000E+00 |
| surface | 10 | 11 | 12 | 13 | 14 | 15 |
| K: | 6.3675E+01 | 7.6276E+01 | −5.6015E+00 | −7.2360E−01 | −6.4193E+00 | −1.0047E+01 |
| A: | 0.0000E+00 | 0.0000E+00 | 0.0000E+00 | 0.0000E+00 | 0.0000E+00 | 0.0000E+00 |
| B: | −8.1710E−03 | −2.8634E−02 | −5.3211E−02 | −6.1539E−02 | −7.1772E−03 | 1.4361E−02 |
| C: | 7.7617E−04 | 1.8142E−02 | 2.7792E−02 | 2.3463E−02 | −4.3516E−03 | −1.0071E−02 |
| D: | −5.6866E−03 | −1.2862E−02 | −1.2083E−02 | −7.1374E−03 | 1.6798E−03 | 2.8464E−03 |
| E: | 5.7345E−03 | 5.8265E−03 | 3.1851E−03 | 1.2989E−03 | −4.0676E−04 | −5.4205E−04 |
| F: | −1.9920E−03 | −1.5453E−03 | −5.1196E−04 | −1.2842E−04 | 4.1839E−05 | 5.9288E−05 |
| G: | 3.1083E−04 | 2.2071E−04 | 4.5872E−05 | 6.3424E−06 | −1.4787E−06 | −3.2847E−06 |
| H: | −1.8553E−05 | −1.2598E−05 | −1.7172E−06 | −1.2148E−07 | 2.4234E−09 | 7.1618E−08 |
| I: | 0.0000E+00 | 0.0000E+00 | 0.0000E+00 | 0.0000E+00 | 0.0000E+00 | 0.0000E+00 |
| J: | 0.0000E+00 | 0.0000E+00 | 0.0000E+00 | 0.0000E+00 | 0.0000E+00 | 0.0000E+00 |

| surface | 16 | 17 |
|---|---|---|
| K: | −6.4865E−01 | −6.0720E+01 |
| A: | 0.0000E+00 | 0.0000E+00 |
| B: | −1.6097E−03 | −1.5063E−02 |
| C: | −1.9206E−03 | 2.1557E−03 |
| D: | 8.2956E−04 | −2.8023E−04 |
| E: | −9.9655E−05 | 2.6948E−05 |
| F: | 5.7944E−06 | −1.6388E−06 |
| G: | −1.6898E−07 | 5.3067E−08 |
| H: | 2.0057E−09 | −6.8251E−10 |
| I: | 0.0000E+00 | 0.0000E+00 |
| J: | 0.0000E+00 | 0.0000E+00 |

In the fifth embodiment, the equation of the aspheric surface profiles of the aforementioned lens elements is the same as the equation of the first embodiment. Also, the definitions of these parameters shown in the following table are the same as those stated in the first embodiment with corresponding values for the fifth embodiment, so an explanation in this regard will not be provided again. It is noted that the diameter of the shading surface in the fifth embodiment is 1.518 mm.

Moreover, these parameters can be calculated from Table 9 and Table 10 as the following values and satisfy the following conditions:

Embodiment 5

| | | | |
|---|---|---|---|
| f[mm] | 6.74 | R13*R14/f7[mm] | 11.635 |
| Fno | 1.82 | (CT1 + CT2 + CT3)/TL | 0.224 |
| FOV[deg.] | 83.81 | (TL − BFL)/f1 | 1.204 |
| f1/R2 | 0.486 | f5/(R9*R10) [mm⁻¹] | 2.215 |
| f2/f7 | 3.440 | TL/f | 1.156 |
| f34/(f1*f2) [mm⁻¹] | 2.627 | IMH/TL | 0.795 |
| f1/f2 | −0.379 | V1 − V2 | 36.800 |
| R1/R2 | 0.216 | f/(R13*R14) [mm⁻¹] | −0.131 |

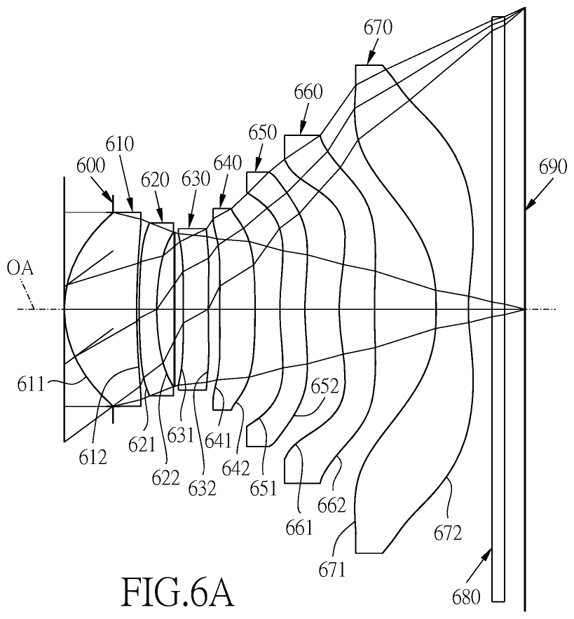

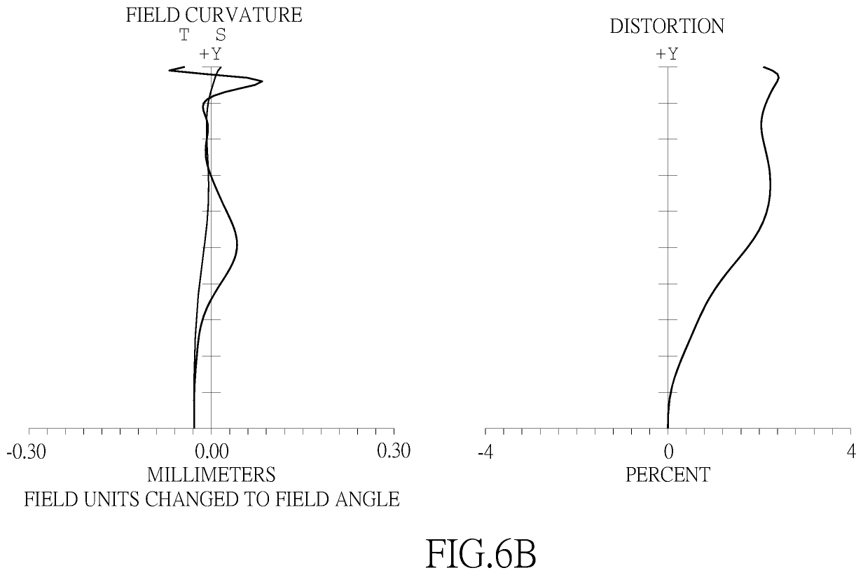

Referring to FIGS. 6A and 6B, FIG. 6A shows a seven-piece optical lens system in accordance with a sixth embodiment of the present invention, and FIG. 6B shows, in order from left to right, the image plane curve and the distortion curve of the sixth embodiment of the present invention. A seven-piece optical lens system in accordance with the sixth embodiment of the present invention comprises a stop 600 and a lens group. The lens group comprises, in order from an object side to an image side: a first lens element 610, a second lens element 620, a third lens element 630, a fourth lens element 640, a fifth lens element 650, a sixth lens element 660, a seventh lens element 670, an IR cut filter 680, and an image plane 690, wherein the seven-piece optical lens system has a total of seven lens elements with refractive power. The stop 600 is disposed between an image-side surface 612 of the first lens element 610 and an object to be imaged.

The first lens element 610 with a positive refractive power has an object-side surface 611 being convex near an optical axis OA and the image-side surface 612 being concave near the optical axis OA, the object-side surface 611 and the image-side surface 612 are aspheric, and the first lens element 610 is made of plastic material.

The second lens element 620 with a negative refractive power has an object-side surface 621 being convex near the optical axis OA and the image-side surface 622 being concave near the optical axis OA, the object-side surface 621 and the image-side surface 622 are aspheric, and the second lens element 620 is made of plastic material.

The third lens element 630 with a negative refractive power has an object-side surface 631 being convex near the optical axis OA and an image-side surface 632 being concave near the optical axis OA, the object-side surface 631 and the image-side surface 632 are aspheric, and the third lens element 630 is made of plastic material.

The fourth lens element 640 with a positive refractive power has an object-side surface 641 being convex near the optical axis OA and an image-side surface 642 being convex near the optical axis OA, the object-side surface 641 and the image-side surface 642 are aspheric, and the fourth lens element 640 is made of plastic material.

The fifth lens element 650 with a negative refractive power has an object-side surface 651 being convex near the optical axis OA and an image-side surface 652 being concave near the optical axis OA, the object-side surface 651 and the image-side surface 652 are aspheric and are provided with at least one inflection point, and the fifth lens element 650 is made of plastic material.

The sixth lens element 660 with a positive refractive power has an object-side surface 661 being convex near the optical axis OA and an image-side surface 662 being concave near the optical axis OA, the object-side surface 661 and the image-side surface 662 are aspheric and are provided with at least one inflection point, and the sixth lens element 660 is made of plastic material.

The seventh lens element 670 with a negative refractive power has an object-side surface 671 being concave near the optical axis OA and an image-side surface 672 being concave near the optical axis OA, the object-side surface 671 and the image-side surface 672 are aspheric and are provided with at least one inflection point, and the seventh lens element 670 is made of plastic material.

The IR cut filter 680 made of glass is located between the seventh lens element 670 and the image plane 690 and has no influence on the focal length of the seven-piece optical lens system.

The detailed optical data of the sixth embodiment is shown in table 11, and the aspheric surface data is shown in table 12.

TABLE 11
Embodiment 6
f(focal length) = 6.74 mm, Fno = 1.75, FOV = 81.7 deg.

| surface | | Curvature Radius | | Thickness | Material | Index | Abbe # | Focal length |
|---|---|---|---|---|---|---|---|---|
| 0 | object | infinity | | infinity | | | | |
| 1 | | infinity | | 0.824 | | | | |
| 2 | stop | infinity | | −0.824 | | | | |
| 3 | Lens 1 | 2.587 | (ASP) | 1.225 | plastic | 1.54 | 56 | 5.80 |
| 4 | | 11.753 | (ASP) | 0.040 | | | | |
| 5 | Lens 2 | 12.144 | (ASP) | 0.300 | plastic | 1.67 | 19.2 | −16.83 |
| 6 | | 5.822 | (ASP) | 0.301 | | | | |
| 7 | shading surface | infinity | | 0.150 | | | | |
| 8 | Lens 3 | 68.982 | (ASP) | 0.426 | plastic | 1.67 | 19.2 | −48.21 |
| 9 | | 22.112 | (ASP) | 0.193 | | | | |
| 10 | Lens 4 | 49.761 | (ASP) | 0.598 | plastic | 1.54 | 56 | 38.87 |
| 11 | | −36.876 | (ASP) | 0.423 | | | | |
| 12 | Lens 5 | 5.448 | (ASP) | 0.420 | plastic | 1.59 | 28.4 | −1113.81 |
| 13 | | 5.249 | (ASP) | 0.585 | | | | |
| 14 | Lens 6 | 4.334 | (ASP) | 0.598 | plastic | 1.54 | 56 | 10.31 |
| 15 | | 17.870 | (ASP) | 1.046 | | | | |
| 16 | Lens 7 | −7.678 | (ASP) | 0.548 | plastic | 1.54 | 56 | −4.99 |
| 17 | | 4.327 | (ASP) | 0.400 | | | | |

| | | | | | | | |
|---|---|---|---|---|---|---|---|
| 18 | IR-filter | infinity | 0.210 | glass | 1.52 | 64.2 | — |
| 19 | | infinity | 0.346 | | | | |
| 20 | Image plane | infinity | — | | | | |

TABLE 12
Aspheric Coefficients

| surface | 3 | 4 | 5 | 6 | 8 | 9 |
|---|---|---|---|---|---|---|
| K: | −6.2356E+00 | 1.3077E+01 | 4.3262E+01 | 2.6604E+00 | 4.9428E+01 | −9.9000E+01 |
| A: | 0.0000E+00 | 0.0000E+00 | 0.0000E+00 | 0.0000E+00 | 0.0000E+00 | 0.0000E+00 |
| B: | 4.2374E−02 | −2.7852E−02 | −2.6466E−02 | −1.9123E−03 | −2.5298E−02 | −1.6896E−02 |
| C: | −8.6998E−03 | 6.1898E−04 | 4.0195E−03 | 9.7234E−03 | 3.3502E−02 | 2.2819E−03 |
| D: | 6.9640E−04 | 4.2365E−02 | 4.6271E−02 | −7.1854E−03 | −8.9614E−02 | 1.5294E−04 |
| E: | 1.0531E−03 | −5.6125E−02 | −6.7921E−02 | 1.3410E−02 | 1.3611E−01 | −1.0349E−02 |
| F: | −5.7205E−04 | 3.7824E−02 | 4.9586E−02 | −2.0028E−02 | −1.2806E−01 | 1.4928E−02 |
| G: | 1.4113E−04 | −1.5362E−02 | −2.1563E−02 | 1.6505E−02 | 7.5048E−02 | −9.9842E−03 |
| H: | −2.0051E−05 | 3.8130E−03 | 5.6699E−03 | −7.4630E−03 | −2.6599E−02 | 3.6503E−03 |
| I: | 1.8505E−06 | −5.3621E−04 | −8.3116E−04 | 1.7751E−03 | 5.2324E−03 | −6.8557E−04 |
| J: | −1.3100E−07 | 3.2802E−05 | 5.1692E−05 | −1.7287E−04 | −4.3855E−04 | 5.1077E−05 |
| surface | 10 | 11 | 12 | 13 | 14 | 15 |
| K: | −9.2334E+00 | 9.9000E+01 | 2.5496E+00 | −6.9549E+00 | −4.2681E+00 | 1.2881E+01 |
| A: | 0.0000E+00 | 0.0000E+00 | 0.0000E+00 | 0.0000E+00 | 0.0000E+00 | 0.0000E+00 |
| B: | −6.1406E−03 | −3.1869E−02 | −7.5080E−02 | −7.8014E−02 | −3.6962E−02 | −1.2049E−02 |
| C: | −2.2946E−02 | 2.8514E−02 | 5.3336E−02 | 5.1322E−02 | 8.7964E−03 | −7.4323E−04 |
| D: | 4.2892E−02 | −3.8482E−02 | −4.2067E−02 | −3.1475E−02 | −4.0029E−03 | −2.8505E−05 |
| E: | −5.3619E−02 | 3.3212E−02 | 2.3790E−02 | 1.4610E−02 | 1.4118E−03 | 2.8760E−04 |
| F: | 3.9628E−02 | −1.9290E−02 | −9.4392E−03 | −4.8998E−03 | −3.1687E−04 | −1.3211E−04 |
| G: | −1.7903E−02 | 7.1993E−03 | 2.4038E−03 | 1.0870E−03 | 2.9509E−05 | 2.5721E−05 |
| H: | 4.8738E−03 | −1.6333E−03 | −3.6323E−04 | −1.4700E−04 | 6.7189E−07 | −2.5120E−06 |
| I: | −7.2454E−04 | 2.0352E−04 | 2.9077E−05 | 1.0889E−05 | −2.6787E−07 | 1.2198E−07 |
| J: | 4.4737E−05 | −1.0554E−05 | −9.2792E−07 | −3.3794E−07 | 1.1428E−08 | −2.3533E−09 |

| surface | 16 | 17 |
|---|---|---|
| K: | 1.3294E+00 | −2.7318E+01 |
| A: | 0.0000E+00 | 0.0000E+00 |
| B: | −6.1012E−02 | −2.9668E−02 |
| C: | 2.1155E−02 | 7.6327E−03 |
| D: | −4.5495E−03 | −1.2423E−03 |
| E: | 6.4999E−04 | 1.1732E−04 |
| F: | −5.9689E−05 | −5.9316E−06 |
| G: | 3.4712E−06 | 8.9844E−08 |
| H: | −1.2363E−07 | 5.4572E−09 |
| I: | 2.4610E−09 | −2.7439E−10 |
| J: | −2.0971E−11 | 3.6736E−12 |

In the sixth embodiment, the equation of the aspheric surface profiles of the aforementioned lens elements is the same as the equation of the first embodiment. Also, the definitions of these parameters shown in the following table are the same as those stated in the first embodiment with corresponding values for the sixth embodiment, so an explanation in this regard will not be provided again. It is noted that the diameter of the shading surface in the sixth embodiment is 1.54 mm.

Moreover, these parameters can be calculated from Table 11 and Table 12 as the following values and satisfy the following conditions:

Embodiment 6

| | | | |
|---|---|---|---|
| f[mm] | 6.74 | R13*R14/f7[mm] | 6.664 |
| Fno | 1.75 | (CT1 + CT2 + CT3)/TL | 0.250 |
| FOV[deg.] | 81.70 | (TL − BFL)/f1 | 1.182 |
| f1/R2 | 0.493 | f5/(R9*R10) [mm⁻¹] | −38.948 |
| f2/f7 | 3.375 | TL/f | 1.158 |
| f34/(f1*f2) [mm⁻¹] | −1.993 | IMH/TL | 0.768 |
| f1/f2 | −0.345 | V1 − V2 | 36.800 |
| R1/R2 | 0.220 | f/(R13*R14) [mm⁻¹] | −0.203 |

In the present seven-piece optical lens system, the lens elements can be made of plastic or glass. If the lens elements are made of plastic, the cost will be effectively reduced. If the lens elements are made of glass, there is more freedom in distributing the refractive power of the seven-piece optical lens system. Plastic lens elements can have aspheric surfaces, which allow more design parameter freedom (than spherical surfaces), so as to reduce the aberration and the number of the lens elements, as well as the total track length of the seven-piece optical lens system. In the present seven-piece optical lens system, if the object-side or the image-side surface of the lens elements with refractive power is convex and the location of the convex surface is not defined, the object-side or the image-side surface of the lens elements near the optical axis is convex. If the object-side or the image-side surface of the lens elements is concave and the location of the concave surface is not defined, the object-side or the image-side surface of the lens elements near the optical axis is concave.

The seven-piece optical lens system of the present invention can be used in focusing optical systems and can obtain better image quality. The seven-piece optical lens system of the present invention can also be used in electronic imaging systems, such as, 3D image capturing, digital camera, mobile device, digital flat panel or vehicle camera.

While we have shown and described various embodiments in accordance with the present invention, it should be clear to those skilled in the art that further embodiments may be made without departing from the scope of the present invention.

What is claimed is:

1. A seven-piece optical lens system, comprising a stop and a lens group having seven lens elements, in order from an object side to an image side:
the stop;
a first lens element with a positive refractive power, having an object-side surface being convex near an optical axis and an image-side surface being concave near the optical axis, at least one of the object-side surface and the image-side surface of the first lens element being aspheric;
a second lens element with a negative refractive power, having an object-side surface being convex near the optical axis and an image-side surface being concave near the optical axis, at least one of the object-side surface and the image-side surface of the second lens element being aspheric;
a third lens element with a refractive power, having an object-side surface being convex near the optical axis and an image-side surface being concave near the optical axis, at least one of the object-side surface and the image-side surface of the third lens element being aspheric;
a fourth lens element with a positive refractive power, having an image-side surface being convex near the optical axis, at least one of an object-side surface and the image-side surface of the fourth lens element being aspheric;
a fifth lens element with a refractive power, having an object-side surface being convex near the optical axis and an image-side surface being concave near the optical axis, at least one of the object-side surface and the image-side surface of the fifth lens element being aspheric;
a sixth lens element with a positive refractive power, having an object-side surface being convex near the optical axis, at least one of the object-side surface and an image-side surface of the sixth lens element being aspheric; and
a seventh lens element with a negative refractive power, having an object-side surface being concave near the optical axis and an image-side surface being concave near the optical axis, at least one of the object-side surface and the image-side surface of the seventh lens element being aspheric and provided with at least one inflection point;
wherein a focal length of the seven-piece optical lens system is f, a radius of curvature of the object-side surface of the seventh lens element is R13, a radius of curvature of the image-side surface of the seventh lens element is R14, and they satisfy the relation: −0.28 mm⁻¹<f/(R13*R14)<−0.10 mm⁻¹.

2. The seven-piece optical lens system as claimed in claim 1, wherein a focal length of the first lens element is f1, a radius of curvature of the image-side surface of the first lens element is R2, and they satisfy the relation: 0.35<f1/R2<0.60.

3. The seven-piece optical lens system as claimed in claim 1, wherein a focal length of the second lens element is f2, a focal length of the seventh lens element is f7, and they satisfy the relation: 2.7<f2/f7<4.5.

4. The seven-piece optical lens system as claimed in claim 1, wherein a focal length of the third lens element and the fourth lens element combined is f34, a focal length of the first lens element is f1, a focal length of the second lens element is f2, and they satisfy the relation: −12.8 mm⁻¹<f34/(f1*f2)<3.2 mm⁻¹.

5. The seven-piece optical lens system as claimed in claim 1, wherein a focal length of the first lens element is f1, a focal length of the second lens element is f2, and they satisfy the relation: −0.5<f1/f2<−0.25.

6. The seven-piece optical lens system as claimed in claim 1, wherein a radius of curvature of the object-side surface of the first lens element is R1, a radius of curvature of the image-side surface of the first lens element is R2, and they satisfy the relation: 0.15<R1/R2<0.27.

7. The seven-piece optical lens system as claimed in claim 1, wherein a focal length of the seventh lens element is f7, the radius of curvature of the object-side surface of the seventh lens element is R13, the radius of curvature of the image-side surface of the seventh lens element is R14, and they satisfy the relation: 5.3 mm<R13*R14/f7<14.0 mm.

8. The seven-piece optical lens system as claimed in claim 1, wherein a central thickness of the first lens element along the optical axis is CT1, a central thickness of the second lens element along the optical axis is CT2, a central thickness of the third lens element along the optical axis is CT3, a distance from the object-side surface of the first lens element to an image plane along the optical axis is TL, and they satisfy the relation: 0.17<(CT1+CT2+CT3)/TL<0.3.

9. The seven-piece optical lens system as claimed in claim 1, wherein a distance from the object-side surface of the first lens element to an image plane along the optical axis is TL, a distance from the image-side surface of the seventh lens element to the image plane along the optical axis is BFL, a focal length of the first lens element is f1, and they satisfy the relation: 0.93<(TL−BFL)/f1<1.45.

10. The seven-piece optical lens system as claimed in claim 1, wherein a focal length of the fifth lens element is f5, a radius of curvature of the object-side surface of the fifth lens element is R9, a radius of curvature of the image-side surface of the fifth lens element is R10, and they satisfy the relation: −46.8 mm⁻¹<f5/(R9*R10)<2.7 mm⁻¹.

11. The seven-piece optical lens system as claimed in claim 1, wherein the focal length of the seven-piece optical lens system is f, a distance from the object-side surface of the first lens element to an image plane along the optical axis is TL, and they satisfy the relation: 0.92<TL/f<1.41.

12. The seven-piece optical lens system as claimed in claim 1, wherein half of an image height that can be captured by the seven-piece optical lens system on an image plane is IMH, a distance from the object-side surface of the first lens element to the image plane along the optical axis is TL, and they satisfy the relation: 0.6<IMH/TL<0.96.

13. The seven-piece optical lens system as claimed in claim 1, wherein an Abbe number of the first lens element is V1, an Abbe number of the second lens element is V2, and they satisfy the relation: 29<V1−V2<45.
